(19) United States
(12) Patent Application Publication
(10) Pub. No.: US 2006/0130329 A1
(43) Pub. Date: Jun. 22, 2006

(54) Method and apparatus for producing a heat exchanger for candy-making compositions

(76) Inventor: Olaf Heinicke, Ratingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/312,336

(22) Filed: Dec. 21, 2005

(30) Foreign Application Priority Data
Dec. 21, 2004 (DE) 10 2004 061 354.0

(51) Int. Cl. B23P 15/26; B21D 53/02

(52) U.S. Cl. 29/890.048; 29/896.6; 29/890.03

(57) ABSTRACT

A method for producing a heat exchanger in which the heat exchanger has a plurality of identically embodied guide baffles which form a helical guide for the composition and which are penetrated by heat exchanger tubes. For making through openings in the guide baffles for the heat exchanger tubes, a mounting device cooperates with a laser beam device. By making the through openings in the guide baffles that have already been provided with their final slope, the through openings can be adapted very precisely to the heat exchanger tubes. As a result, losses from overflow of the composition at the guide baffles are reduced, and the efficiency of the heat exchanger is increased.

### CROSS-REFERENCE TO RELATED APPLICATIONS

This application is based on German Patent Application 10 2004 061 354.0 filed on Dec. 21, 2004, upon which priority is claimed.

### BACKGROUND OF THE INVENTION

1. Field of the Invention

The invention relates to an improved method of and an apparatus for producing a heat exchanger for compositions in the candy-making industry.

2. Description of the Prior Art

From German Patent Disclosure DE 10 2004 028 528 A1, a heat exchanger is known which comprises a plurality of identically embodied guide elements that together form a helix. The guide elements are penetrated by tubes for a heating medium or cooling medium that are located parallel to the longitudinal axis of the housing jacket of the heat exchanger. The guide elements are embodied either with a steady curvature or in other words helically, or they also, in addition to guide portions that extend perpendicular to the longitudinal axis of the housing jacket, have guide portions that extend obliquely to the longitudinal axis of the housing jacket.

To assure that a candy composition that must conventionally be heated will always follow the guide elements and not move from one side of the guide element directly to the other side in the region of the openings for the tubes, it is necessary to adapt the openings for the tubes at the guide elements as exactly as possible to the tubes themselves. This is problematic, because the regions of the guide elements that extend obliquely to the longitudinal axis of the heat exchanger require oval openings for the sake of freedom from gaps, and these openings, depending on the slope of the helix must be shaped differently from the inside outward. It would be conceivable, for the sake of the simplest possible production, to embody the openings as round bores with a large oversize. The resultant gaps existing between the openings of the tubes, because of the faster passage through them of the composition from the inlet side to the outlet side of the heat exchanger, reduce the efficiency. To increase the efficiency, it could be attempted that the gaps be welded, for instance. However, this goes against the demand for economical production and in practice is hardly feasible, because of the close arrangement of individual tubes.

### OBJECT AND SUMMARY OF THE INVENTION

It is therefore the object of the invention to furnish a method for producing a heat exchanger which makes especially high efficiency of a heat exchanger possible at reasonable cost. This object is attained by the characteristics of claim 1 essentially in that the openings for the tubes are not made in the guide elements until the applicable guide element has been put into its form required for the helical guide. As a result, the shape of the openings can be adapted exactly, or in other words with a minimal gap, to the tubes.

It is especially advantageous to make the openings by means of a laser beam device, since this makes rational production possible. Advantageous refinements of the method of the invention, and an apparatus suitable for performing the method, are disclosed.

### BRIEF DESCRIPTION OF THE DRAWINGS

The invention will be better understood and further objects and advantages thereof will become more apparent from the ensuing detailed description of a preferred embodiment, taken in conjunction with the drawings, in which:

FIG. 1 shows a heat exchanger in perspective and partly in section;

FIG. 2 is a perspective view of an apparatus according to the invention for making the openings in a guide element;

FIG. 3 shows the apparatus of FIG. 2 from a different perspective; and

FIG. 4 is a side view on the apparatus of FIGS. 2 and 3 during the production of the openings in a guide element.

### DESCRIPTION OF THE PREFERRED EMBODIMENT

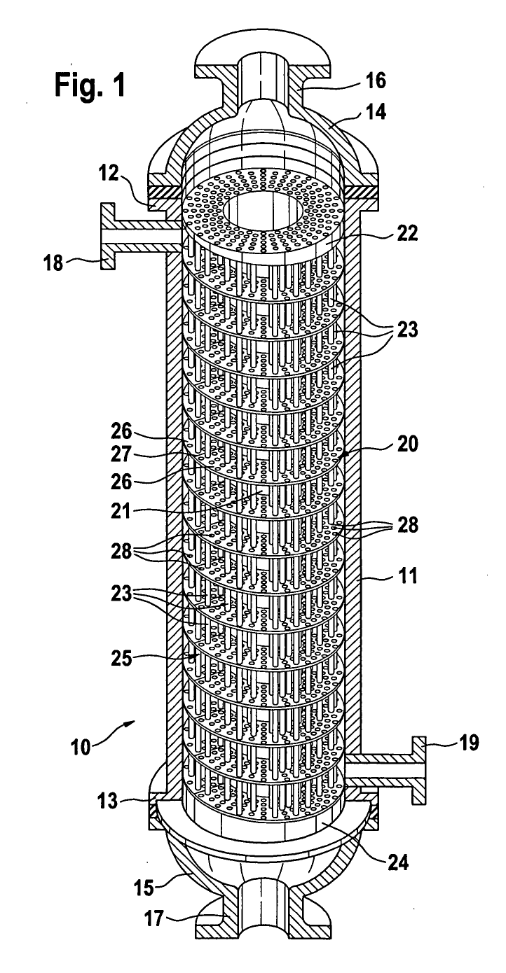

In FIG. 1, a heat exchanger 10 is shown, of the kind used in a candy-making industry for producing or processing such compositions as sugar/glucose solutions or the like. The heat exchanger 10 has a hollow-cylindrical housing jacket 11, which is only partly visible in FIG. 1, for the sake of simplicity. On each of its face ends, the housing jacket 11 has a respective connection flange 12, 13, which is connected to a respective closure piece 14, 15. The closure pieces 14, 15, which are bell-shaped, each have an inlet 16 and an outlet 17 for a heating or cooling medium. Also in the housing jacket 11, near the connection flanges 12, 13, there are an inlet neck 18 and an outlet neck 19 for the composition to be heated or cooled; these are shown only in simplified form in FIG. 1.

A heat exchanger insert 20 can be inserted into the interior of the housing jacket 11. The heat exchanger insert 20 has a tubular support element 21, which is located centrally in the longitudinal axis of the housing jacket 11 and extends between the two connection flanges 12, 13. The support element 21 may likewise have a flow of heating and cooling medium through it. In the space between the support element 21 and the housing jacket 1 1, a plurality of heat exchanger tubes 23 are provided, which each extend parallel to one another and end in the connection flanges 12, 13, which have suitable through bores for this purpose. The heating or cooling medium is transported inside the heat exchanger tubes 23, specifically from the direction of the inlet 16 in the direction of the outlet 17. Moreover, a helically embodied guide element 25 for the composition to be heated or cooled extends in the space between the support element 21 and the housing jacket 11. The guide element 25 is adjoined in the region of the inlet neck 18 by an inlet adapter 22 and in the region of the outlet neck 19 by an outlet adapter 24.

The guide element 25, in this exemplary embodiment, comprises many annularly or helically embodied guide baffles 26, which adjoin one another and form the helical guide for the composition. To that end, the guide baffles 26 are welded together, for instance, at their narrow face ends 27 and are joined to the support element 21 on their inner circumference.

In the exemplary embodiment, the disposition of the guide baffles 26 inside the housing jacket 11 is such that over the entire length of the heat exchanger 10 between the inlet adapter 22 and the outlet adapter 24, there is the same pitch or slope, or in other words the same spacing between individual guide baffles 26.

In the guide baffles 26, there are through openings 28, corresponding to the disposition of the heat exchanger tubes 23, so that the heat exchanger tubes 23 can be installed or positioned when the guide baffles 26 have been installed on the support element 21. The various gaps between the through openings 28 and the heat exchanger tubes 23 are made as small as possible, so that the composition will be hindered from passing through the various gaps.

It is noted in addition that in the view in FIG. 1, for the sake of clarity, only some of the heat exchanger tubes 23 are shown, while at the guide baffles 26 all the through openings 28 are shown.

The heat exchanger 10 functions as follows: The composition to be heated or cooled passes via the inlet neck 18 into the space between the housing jacket 11 and the support element 21. Since the inflow of the composition takes place under pressure, the composition moves from the inlet neck 18 to the outlet neck 19 within the helical courses that are defined by the guide baffles 26. During the passage through the heat exchanger 10, the composition to be heated or cooled is in contact with the heat exchanger tubes 23, through which a corresponding heating medium or cooling medium flows, and the heating medium or cooling medium enters the heat exchanger 10 through the inlet 16 and is removed from it via the outlet 17.

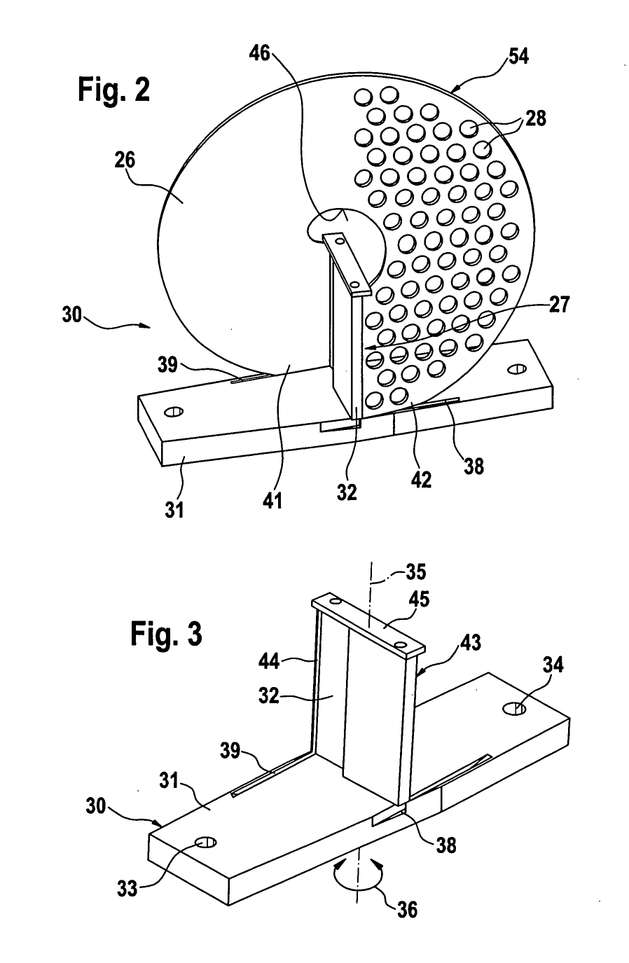

For producing the heat exchanger 10 and in particular for producing the through openings 28 for the heat exchanger tubes 23 in the guide baffles 26, FIGS. 2 through 4 will now be described. A mounting device 30 can be seen, which has an approximately rectangular base plate 31 and a mounting plate 32 that is joined to the base plate 31. One through bore 33, 34 is made on the diametrically opposed sides in the base plate 31, which makes it possible to flange the base plate 31 to an adapter of a turning gear (not shown). By means of the turning gear, the base plate 31 can be rotated in the direction of the arrow 36 in the same axis 35 in which the mounting plate 32 is also disposed.

In the base plate 31, in the region of each of the diametrically opposed broad sides, a respective slitlike milled recess or groove 38, 39 is embodied, spaced only slightly apart from the edge of the base plate 31, and this milled recess is suitable for receiving the respective portion 41, 42 of a guide baffle 26 by its outer circumference. The mounting plate 32, located in the middle between the two through bores 33, 34 and perpendicular to the base plate 31, also has one milled recess or groove 43, 44 each on the respective sides facing toward the face ends 27 of the guide baffle 26, for receiving the guide baffle 26 by its corresponding face end 27. By means of the mounting device 30 described thus far, a guide baffle 26 can be positioned in its installed position that is required and contemplated in the heat exchanger 10; before it is installed in the mounting device 30, the guide baffle 26 is provided with or preshaped with a suitable slope.

To fix the guide baffle 26 in the mounting device 30, or in its milled recesses 38, 39, 43, 44, a rectangular fixation plate 45 is provided, which can be secured by means of screws to the mounting plate 32 that protrudes to the height of the central opening 46 in the guide element 26. The fixation plate 45 protrudes into the opening 46 and thus positions the guide baffle 26 in the milled recesses 38, 39, 43, 44.

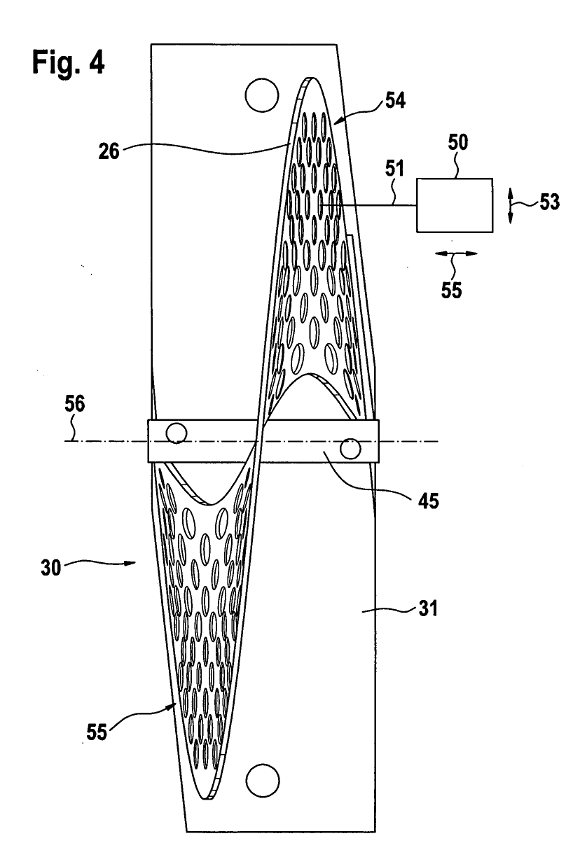

In FIG. 4, a laser beam device 50 is schematically represented. The laser beam device 50 generates a laser beam 51 for making the through openings 28 in the guide baffle 26. The laser beam device 50 is movable by means of an actuator both in the direction of the double arrows 53, 55 and perpendicular to the plane of the drawing in FIG. 4 in the region of the guide baffle 26 in which the through openings 28 are to be made. The making of the through openings 28, for manufacturing reasons, because the through openings 28 are close to the apparatus and would collide with the laser head of the laser beam device 50, are made in two successive work steps. In a first work step, first those through openings 28 that are located on a half sector 54 of the guide baffle (see FIG. 2) are made. For each through opening 28, the laser beam 51 is moved in the plane perpendicular to the axis 56 along a circular path whose diameter, taking appropriate assembly tolerances into account, is essentially equivalent to the diameter of the heat exchanger tubes 23. Next, the guide baffle 26, along with the mounting device 30, is rotated by 180° about the axis 35, so that the other half sector 55 can be machined accordingly. Once the through openings 28 have been made in both half sectors 54, 55, the guide baffle 26 can be removed from the mounting device 30, so that the through openings 28 can be made in the next guide baffle 26.

The installation of the guide baffles 26 in the heat exchanger 10 is done by first threading the individual guide baffles 26 onto the tubular support element 21; the diameter of the support element 21 is adapted to the width of the opening 46 in the guide baffles 26. As a result, a prealignment of the guide baffles 26 can be attained. Next, some of the heat exchanger tubes 23 are threaded through the through openings 28, as a result of which, and also because of the exact axial alignment of the laser-made through openings 28, the final alignment of the guide baffles 26 is obtained. Then, the thus-aligned guide baffles 26 are joined, in particular welded, to the support element 21. Finally, the remaining heat exchanger tubes 23 can be installed, and the thus-formed unit, once it has been provided with the inlet adapter 22 and the outlet adapter 24, can be thrust into the housing jacket 11.

The foregoing relates to a preferred exemplary embodiment of the invention, it being understood that other variants and embodiments thereof are possible within the spirit and scope of the invention, the latter being defined by the appended claims.

I claim:

1. A method for producing a heat exchanger which in a hollow-cylindrical housing jacket is closed off by end pieces and has a plurality of tubes for a heating medium, located parallel to one another, which extend parallel to the longitudinal axis of the housing jacket, and having a helical guide, located in the housing jacket, for the composition to be heated and cooled, the guide including a plurality of identically embodied guide elements that in at least some regions have portions, extending obliquely to the longitudinal axis of the housing jacket, in which portions through openings through which the tubes extend are embodied, the method comprising the steps of preshaping the guide elements in their at least nearly final form before the through openings are made and installing the preshaped guide elements in a mounting device, which cooperates with a device for creating the through openings.

2. The method as defined by claim 1, wherein the guide elements comprise bent sheet-metal parts; and wherein the device for creating the through openings generates a laser beam.

3. The method as defined by claim 2, wherein the through openings are created in two separate work steps, and in each of the two work steps, all the through openings in one of two regions of the respective guide element are created, and between the two work steps, the guide element is rotated by 180° about an axis.

4. The method as defined by claim 1, further comprising the steps of threading the guide elements onto a tubular element after the through openings have been made, the guide elements each having corresponding openings for the tubular element; inserting at least one tube through the through openings, aligned with one another, of the guide elements; and joining the guide elements to the tubular element by welding.

5. The method as defined by claim 2, further comprising the steps of threading the guide elements onto a tubular element after the through openings have been made, the guide elements each having corresponding openings for the tubular element; inserting at least one tube through the through openings, aligned with one another, of the guide elements; and joining the guide elements to the tubular element by welding.

6. The method as defined by claim 3, further comprising the steps of threading the guide elements onto a tubular element after the through openings have been made, the guide elements each having corresponding openings for the tubular element; inserting at least one tube through the through openings, aligned with one another, of the guide elements; and joining the guide elements to the tubular element by welding.

7. An apparatus for performing the method as defined by claim 1, the apparatus comprising a mounting device in which the guide elements are installed for making the through openings, the mounting device having receptacles for regions of the guide element, which fix the guide element in a position corresponding to the installed position in the heat exchanger.

8. An apparatus for performing the method as defined by claim 2, the apparatus comprising a mounting device in which the guide elements are installed for making the through openings, the mounting device having receptacles for regions of the guide element, which fix the guide element in a position corresponding to the installed position in the heat exchanger.

9. An apparatus for performing the method as defined by claim 3, the apparatus comprising a mounting device in which the guide elements are installed for making the through openings, the mounting device having receptacles for regions of the guide element, which fix the guide element in a position corresponding to the installed position in the heat exchanger.

10. An apparatus for performing the method as defined by claim 4, the apparatus comprising a mounting device in which the guide elements are installed for making the through openings, the mounting device having receptacles for regions of the guide element, which fix the guide element in a position corresponding to the installed position in the heat exchanger.

11. The apparatus as defined by claim 1, wherein the mounting device further comprising a base plate and a mounting plate joined to the base plate, in which plates the receptacles are embodied in the form of milled recesses.

12. The apparatus as defined by claim 2, wherein the mounting device further comprising a base plate and a mounting plate joined to the base plate, in which plates the receptacles are embodied in the form of milled recesses.

13. The apparatus as defined by claim 3, wherein the mounting device further comprising a base plate and a mounting plate joined to the base plate, in which plates the receptacles are embodied in the form of milled recesses.

14. The apparatus as defined by claim 4, wherein the mounting device further comprising a base plate and a mounting plate joined to the base plate, in which plates the receptacles are embodied in the form of milled recesses.

15. The apparatus as defined by claim 11, further comprising a fixation for positioning the guide element in the milled recesses.

16. The apparatus as defined by claim 1 1, further comprising a turning gear, and connections for mounting the base plate to the turning gear.

17. The apparatus as defined by claim 15, further comprising a turning gear, and connections for mounting the base plate to the turning gear.

18. The apparatus as defined by claim 7, further comprising a laser beam device spaced apart from the mounting device which laser beam device producing a laser beam aligned with the guide element.

19. The apparatus as defined by claim 1 1, further comprising a laser beam device spaced apart from the mounting device which laser beam device producing a laser beam aligned with the guide element.

20. The apparatus as defined by claim 15, further comprising a laser beam device spaced apart from the mounting device which laser beam device producing a laser beam aligned with the guide element.
